(19) United States
(12) Patent Application Publication
(10) Pub. No.: US 2025/0041896 A1
(43) Pub. Date: Feb. 6, 2025

(54) LIQUID SEALANT PACK AND DISPENSING SYSTEM

(71) Applicant: LOUISIANA-PACIFIC CORPORATION, NASHVILLE, TN (US)

(72) Inventors: NEIL FREIDBERG, LEBANON, TN (US); RYLIE BARLING, NASHVILLE, TN (US); FRANK ROZENBAUM, LEBANON, TN (US)

(21) Appl. No.: 18/791,319

(22) Filed: Jul. 31, 2024

Related U.S. Application Data
(60) Provisional application No. 63/530,033, filed on Jul. 31, 2023.

(51) Int. Cl. B05C 17/01

(52) U.S. Cl. CPC B05C 17/01

(57) ABSTRACT

A backpack and dispensing system for dispensing a caulking or liquid sealant. The pack or backpack houses multiple sealant tubes or cartridges in a pressing device. The pressing device simultaneously applies pressure automatically to each of the multiple sealant tubes or cartridges, which are held in cylindrical holders or holding tubes, causing sealant from each to converge in a converging funnel or connector, where it then passes through a hose or tube to be applied through an application gun, which may be permanently or removably connected to the hose. The converging funnel or connector may be designed to aid in elongating the liquid sealant for application. The gun, which is controlled by a trigger, may use a special sealant tip, which may be removably attached to the gun.

This application claims benefit of and priority to U.S. Provisional App. No. 63/530,033, filed Jul. 31, 2023, which is incorporated herein in its entirety by specific reference for all purposes.

### FIELD OF INVENTION

This invention relates to a pack and dispensing system for dispensing a caulking or liquid sealant.

### BACKGROUND OF INVENTION

Sealing seams for an exterior bonded or integrated weather resistant barrier (WRB) sheathing panel is typically done with a sealing tape or a liquid sealant. At present, liquid sealant is applied using a two-handed caulking gun and squeegee/spreader. The user uses the caulking gun to apply the liquid sealant to the gap between the panels and the outer surface of the panels immediately adjacent or proximate to the gap. The user then must set down the caulking gun, and pick up and use the squeegee to spread the liquid sealant on the outer surface of the panels to the recommended thickness.

Frequently the user is applying the liquid sealant to a wall or roof structure above the ground, and often when standing on a ladder. The current application process requires the user to use both hands, and they thereby lose the three points of contact required for safe use of a ladder. In addition, the amount of liquid sealant in the tube inserted in the caulking gun typically runs out after about 24 feet, which requires frequent replacement and downtime, resulting in significant time and labor costs.

### SUMMARY OF INVENTION

In various exemplary embodiments, as the present invention comprises a backpack and dispensing system for dispensing a caulking or liquid sealant. The pack or backpack houses multiple sealant tubes or cartridges in a pressing device. The pressing device simultaneously applies pressure automatically to each of the multiple sealant tubes or cartridges, which are held in cylindrical holders or holding tubes, causing sealant from each to converge in a converging funnel or connector, where it then passes through a hose or tube to be applied through an application gun, which may be permanently or removably connected to the hose. The converging funnel or connector may be designed to aid in elongating the liquid sealant for application. The gun, which is controlled by a trigger, may use a special sealant tip, which may be removably attached to the gun. The sealant becomes activated when it contacts air, and remains in liquid form until it exits the tip.

### BRIEF DESCRIPTION OF THE DRAWINGS

FIG. 1A shows a cutaway view of a liquid sealant pack with internal insulated tubes and pressing device, and external sealant hose and gun attachment in accordance with an exemplary embodiment of the present invention.

FIG. 1B shows a front external view of the sealant pack of FIG. 1A.

FIG. 1C shows a back external view of the sealant pack of FIG. 1A.

FIG. 2 shows a perspective view of the insulated tubes and pressing device with sealant hose and gun.

FIG. 3 shows a view of six insulated tubes and daisy head apparatus from the sealant pack of FIG. 1.

FIG. 4 shows a view of a daisy head apparatus without tubes.

FIG. 5 shows a cross-section of a cylindrical holding tube.

FIG. 6 shows another view of daisy head apparatus in a raised position.

FIG. 7 shows a view of the daisy head apparatus and run out signal sensor.

FIG. 8 shows a view of the with motor with battery attachment.

FIG. 9 shows an exploded view of the compression apparatus with motor.

FIG. 10 shows a perspective assembled view of FIG. 9.

FIGS. 11 and 12 show closed (clamped) and open (unclamped) and views of the daisy head and tubes.

FIGS. 13 and 14 show open (unclamped) and closed (clamped) views of the daisy head clamping mechanism.

FIG. 15 shows an exploded view of the motor, motor housing and converging funnel.

FIG. 16 shows a view of an application gun and tip.

FIG. 17 shows an exploded view of the dispensing system.

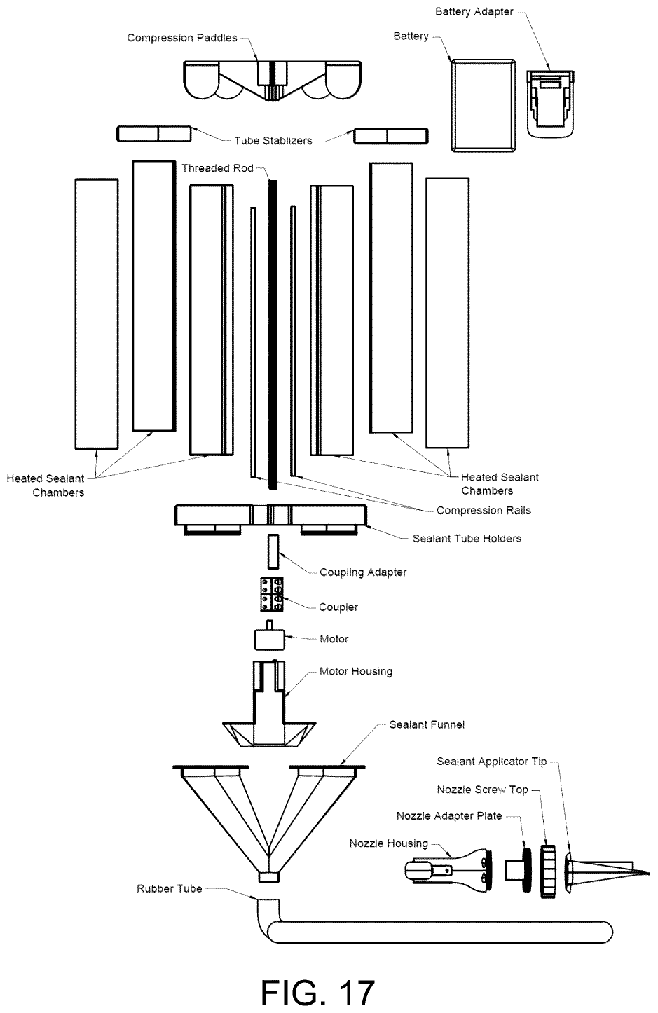

### DETAILED DESCRIPTION OF EXEMPLARY EMBODIMENTS

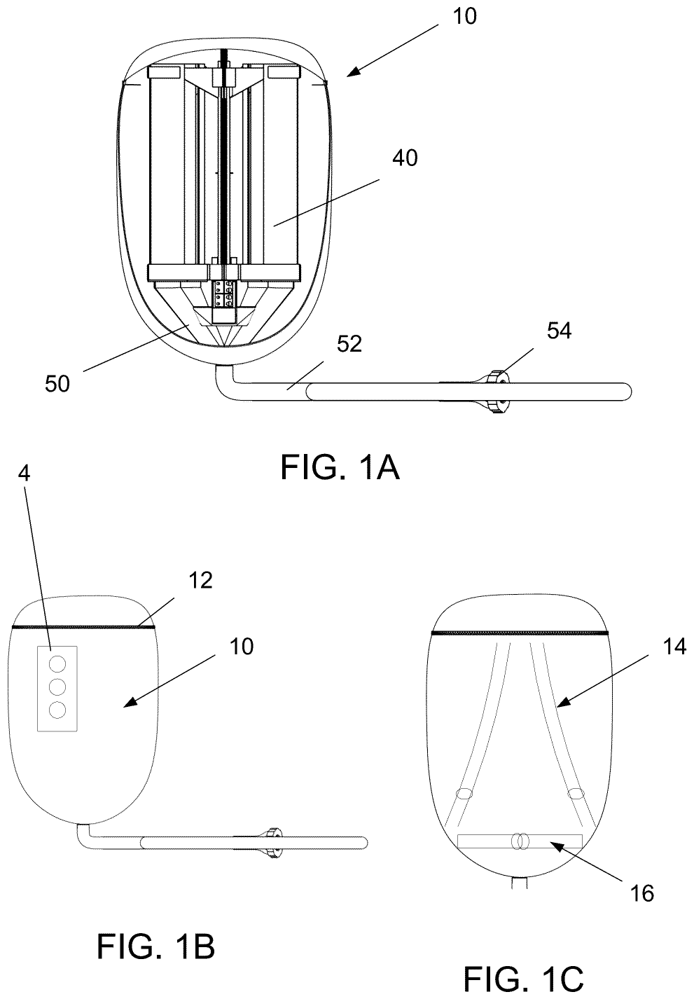

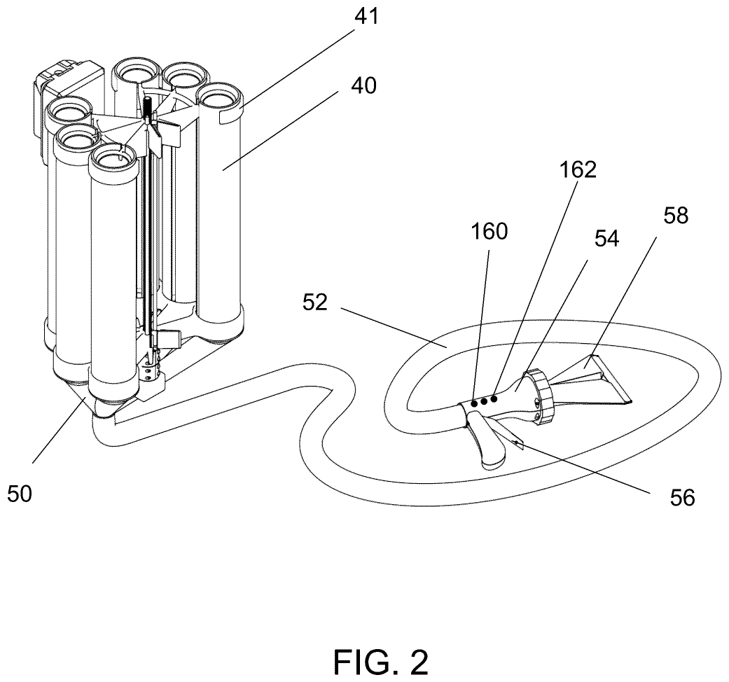

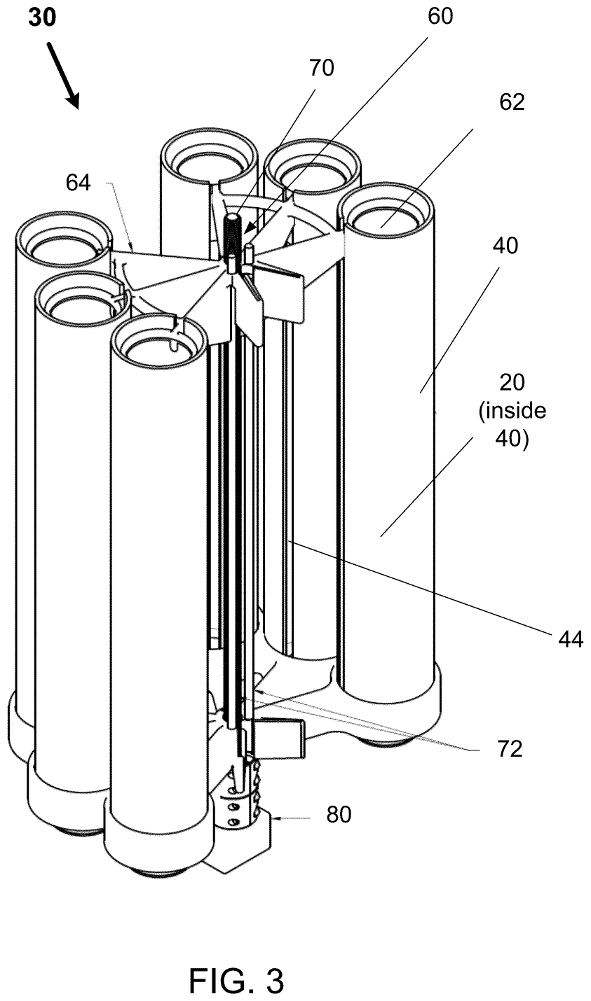

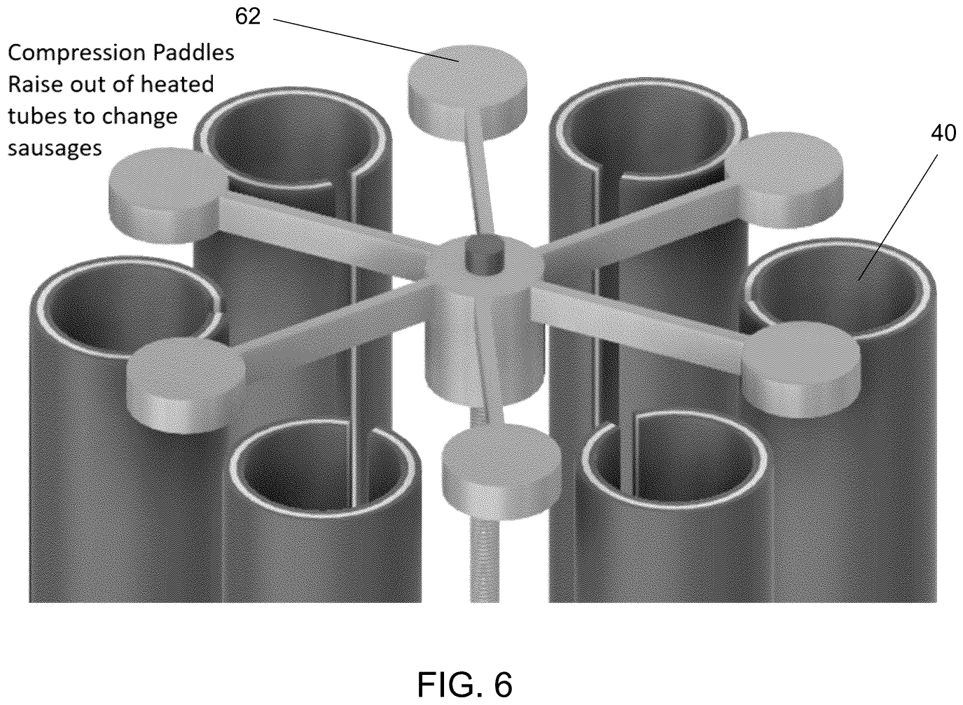

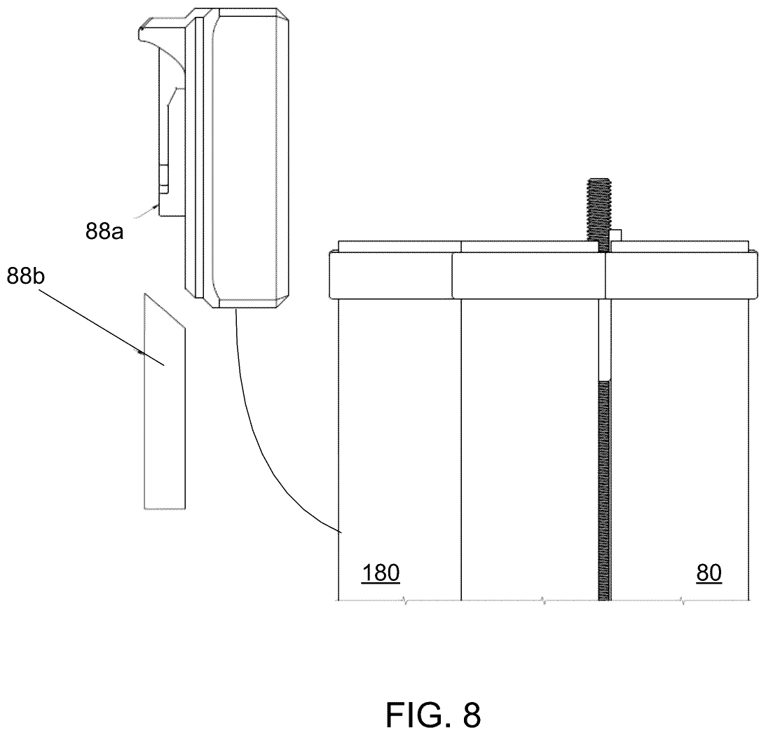

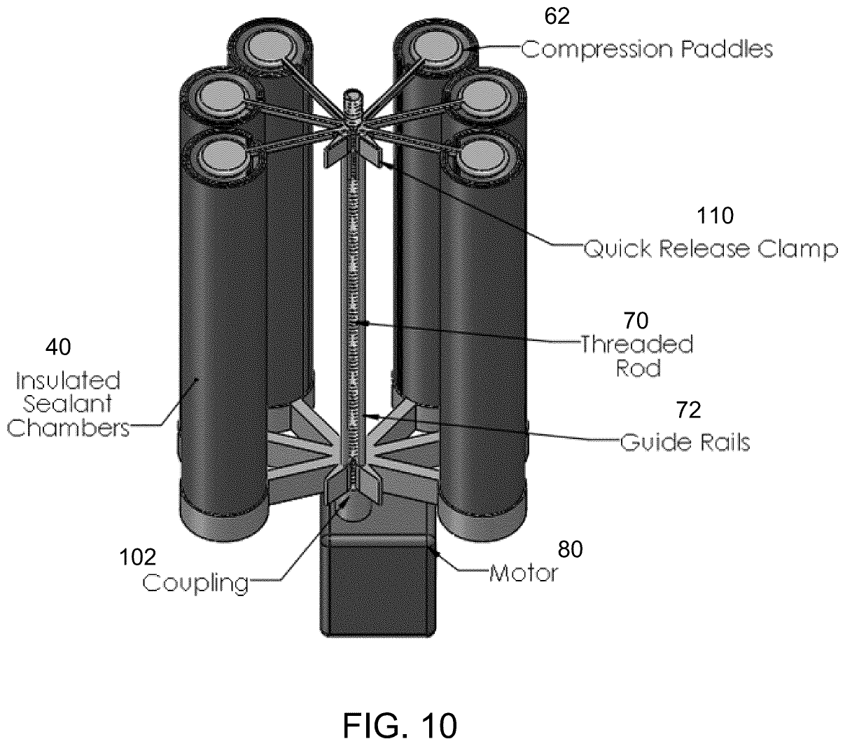

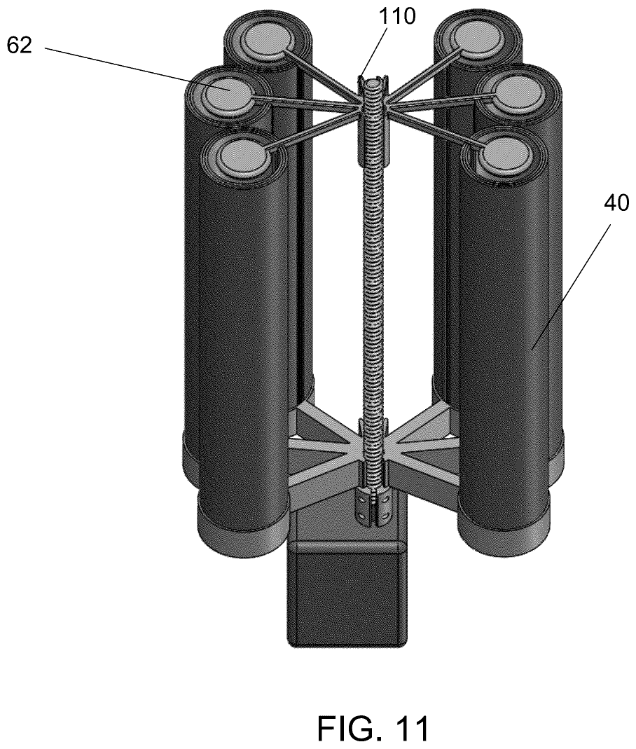

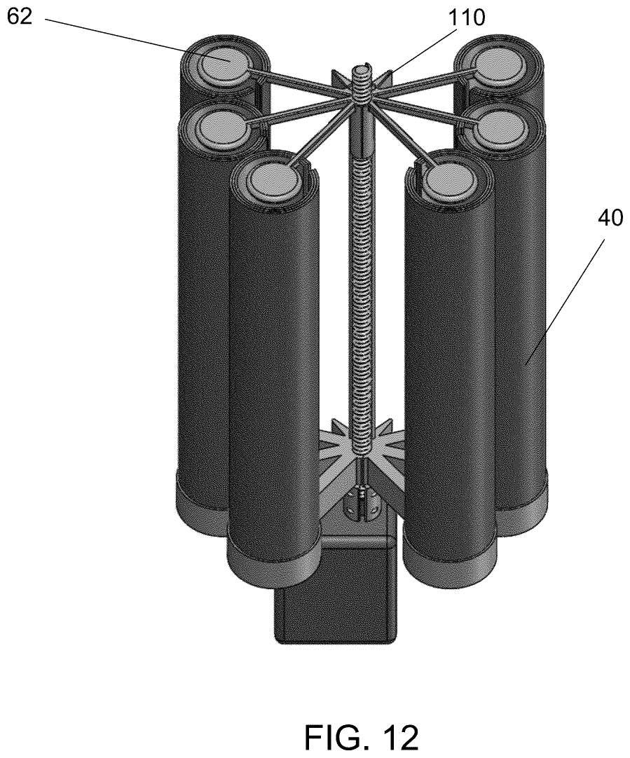

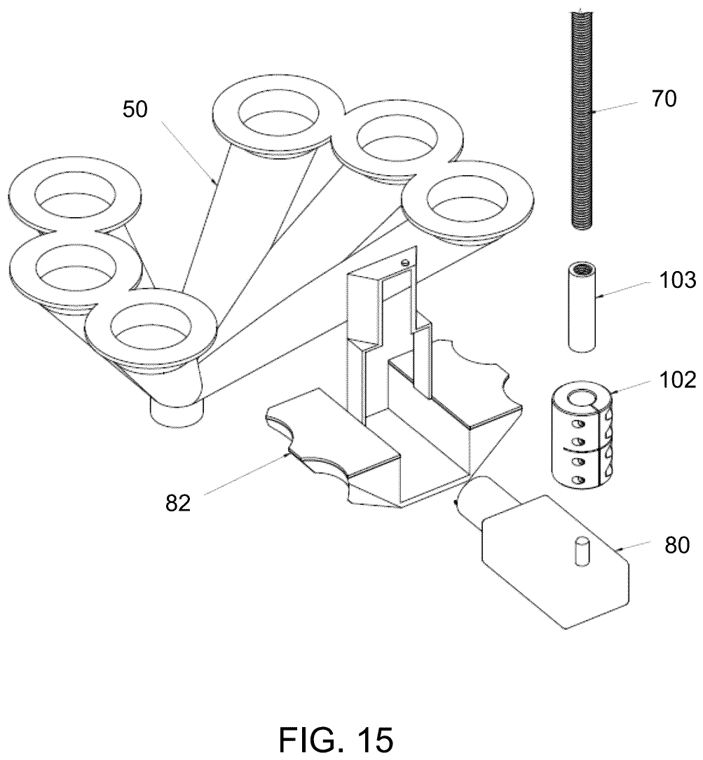

In various exemplary embodiments, as seen in FIGS. 1-15, the present invention comprises a pack and dispensing system for dispensing a caulking or liquid sealant. As compared to prior art caulk and/or sealant applicators, the present invention allows the user to dispense a greater amount of caulk or liquid sealant before running out, thereby reducing downtime in dispensing and refilling. The present invention does not require new or larger tubes, cartridges or “sausage packs,” as it works with the standard size tubes and cartridges used in prior art two-handed caulking guns.

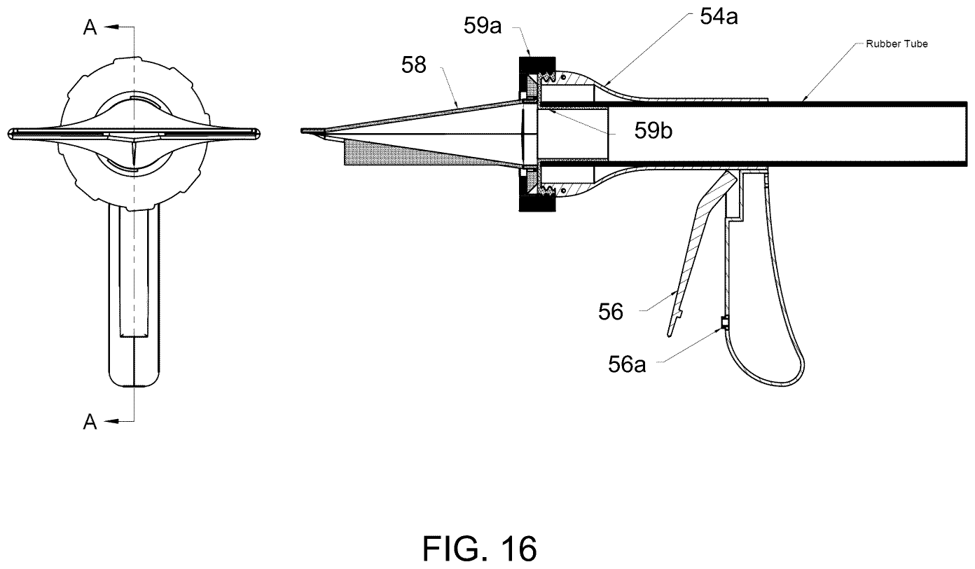

As seen in FIGS. 1A-B and 2-3, the pack or backpack 10 has an interior chamber or space in which it houses multiple sealant tubes or cartridges 20 in a pressing device 30. The pressing device 30 simultaneously applies pressure automatically to each of the multiple sealant tubes or cartridges 20, which are held in cylindrical holders or holding tubes 40, causing sealant from each to converge in a converging funnel or connector 50, where it then passes through a hole in the narrow end of the funnel 50 into and through a hose or tube 52 to be applied through an application gun or nozzle 54, which may be permanently or removably connected to the hose. The converging funnel or connector 50 may be designed to aid in elongating the liquid sealant for application. The gun 54, which is controlled by a trigger 56 (such as when the trigger touches a contact or button 56a to start paddle compression), may use a special sealant tip 58, which may be removably attached to the gun housing 54a (such as by a screw top 59a and/or adapter plate 59b, as seen in FIG. 16). The sealant becomes activated when it contacts air, and remains in liquid form until it exits the tip. FIG. 16 shows a front and cross-sectional side view of a gun and flattened tip. The tip is described in more detail in U.S. patent application Ser. No. 18/401,590, filed Dec. 31, 2023, which is incorporated herein by specific reference in its entirety for all purposes.

The pack or backpack is of general form and material as backpacks known in the prior art, with a body with a cover top (which may be attached in whole or in part by a zipper 12), with shoulder straps 14 which a user may use to carry over one or both shoulders. A belt 16 may be used to secure the bottom of the pack to the user's middle or core section, and to help transfer weight from the shoulders to the user's hips. The interior of the pack may be insulated and/or heated.

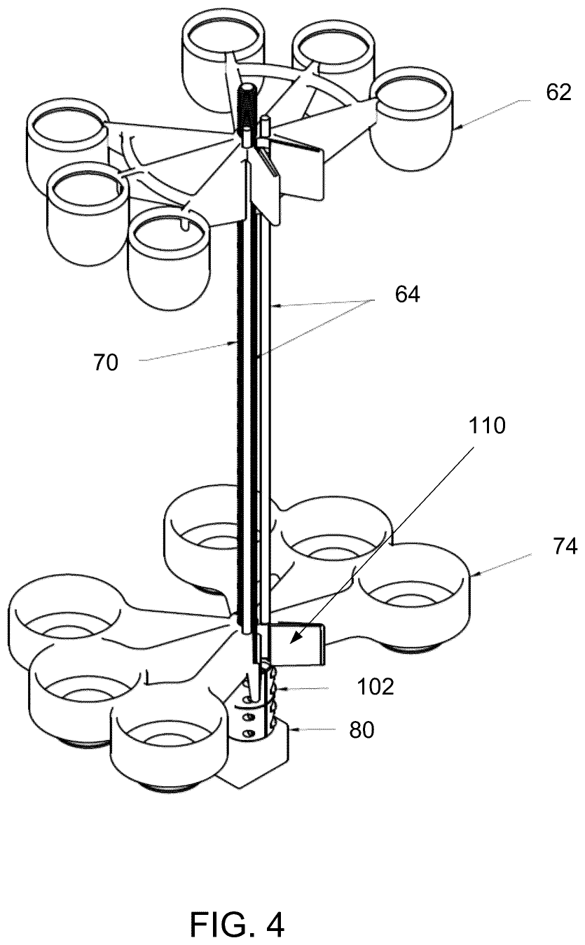

The pressing device 30 comprises a plurality of cylindrical holders or holding tubes 40, with each holder configured to receive and contain a sealant tube or cartridge 20. The holding tubes 40 may be heated and/or insulated. Tube stabilizers 41 may be placed around and/or among the tubes to help hold them in place (as seen in FIG. 2, each set of three adjacent tubes may have a stabilizer connecting them at their tops around the outer circumference except for the innermost section. Each holder 40 comprises an opening at the top for removal and insertion of sealant tubes or cartridges, and a linear slot 44 in the side running the length, or most of the length, of the holder.

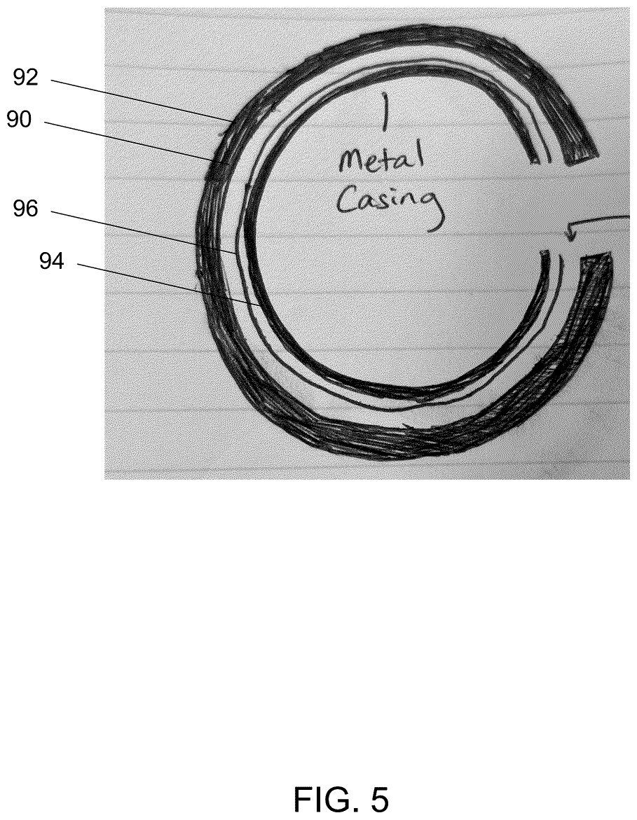

A “daisy head” 60 has a plurality of tube compressors, compression heads, or compression paddles 62 at the end of a matching plurality of rods 64 emanating from the center of the daisy head. The tube compressors or compression paddles 62 fit inside the cylindrical holders 40, and the matching rod 64 passes through the linear slot 44. The compression paddles 62 may be flat, curved, rounded, or elongated with a curved head designed to push the end of end of the sealant tube or cartridge. The center of the daisy head is threaded onto a spiral or threaded rod or screw 70 attached to a motor 80 (such as by a coupler 102 and coupling adapter 103) as seen in FIGS. 3 and 4 and 15. The motor may be secured in a motor housing 82, adjacent to or incorporated into a holder frame 74 located near or at the bottom of the threaded rod or screw, with a plurality of receivers configured to receive the bottom end of the holding tubes (not shown in this figure). The receivers have a male attachment underneath configured to fit within a matching female receiver in the converging funnel 50. Sealant under pressure flows from the bottom of the sealant container into the corresponding channels in the converging funnel and then through the hose or tube to the gun, as described above. The hose or tube may be rubber, plastic, or similar material.

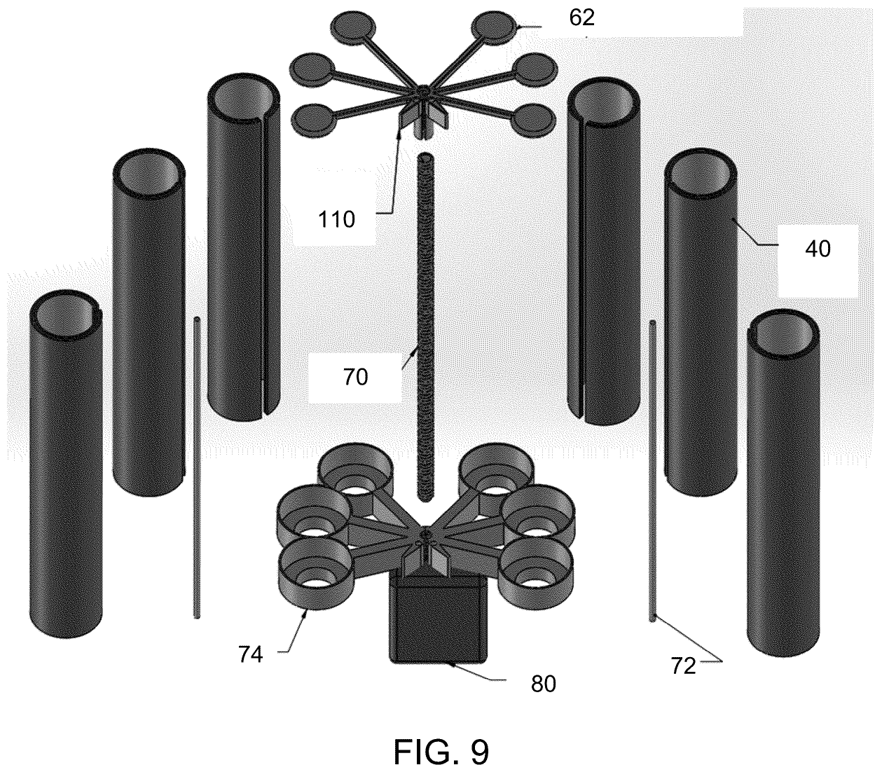

When the motor 80 is activated in application mode, the screw 70 turns and drives (or pulls, if the motor operates in reverse) the daisy head away from the holder upper opening, thereby applying pressure through the respective tube compressors to the sealant tube or cartridge contained in the respective holder. Compressor guide rails or rods 72 may run alongside the threaded rod or screw 70, and run through corresponding holes or slots in the daisy head to help keep the daisy head centered and on track as it moves up and down. Each sealant tube or cartridge is compressed simultaneously, not sequentially, so that each tube or cartridge is exhausted at approximately the same time. A button or contact may be provided to indicate when the daisy head has been driven to the point where the sealant tubes or cartridges are empty or nearly empty. In one embodiment, as seen in FIG. 7, a rod or button 102 on the daisy head contacts a corresponding rod or button or runout sensor 104 on the holder frame to indicate when the tubes or cartridges are empty or nearly empty.

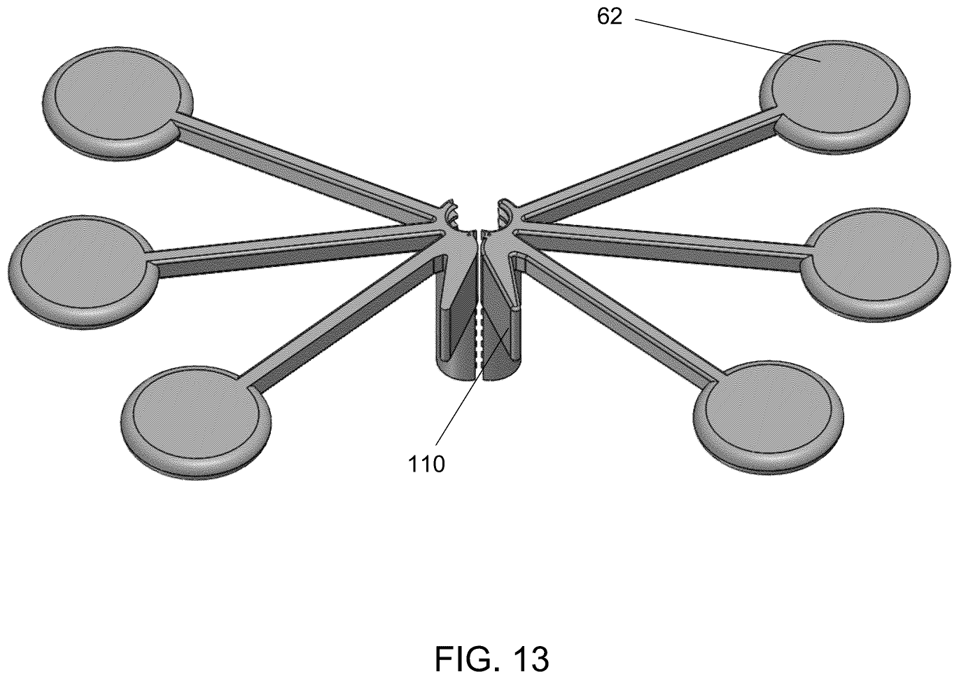

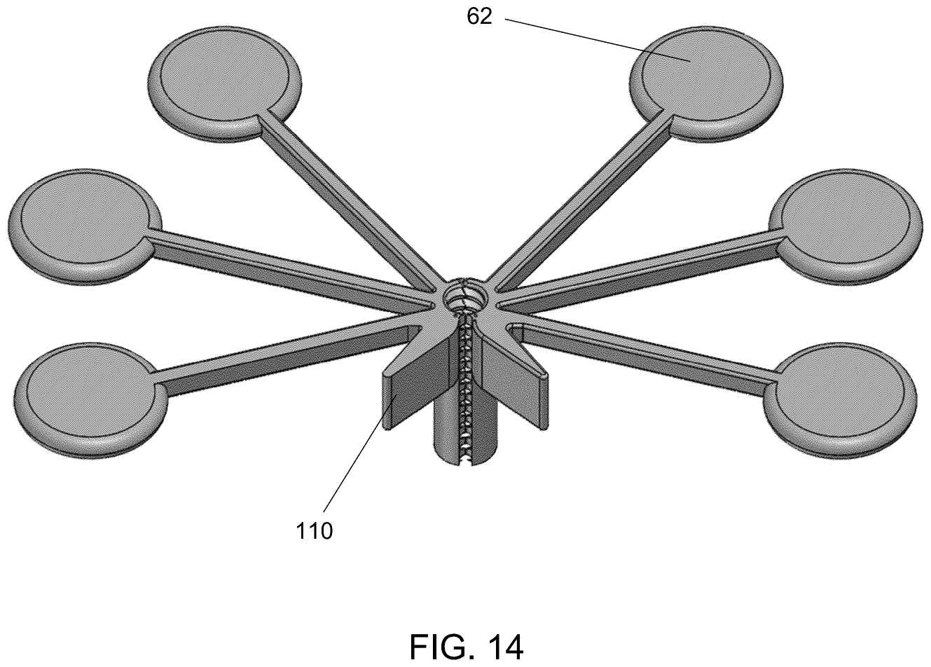

The compressors and the holders may be unclamped from the threaded screw (such as by a quick-release coupling or clamp 110), and pulled out freely so that exhausted tubes or cartridges can be removed and replace with full tubes or cartridges. FIGS. 11 and 14 show a view of the daisy head in clamped or closed position, and FIGS. 12 and 13 show the daisy head in unclamped or open position. As seen in the figures, in a closed position, two curved center pieces come together to form a threaded center hole to engage the threaded rod, while in an open position, the two curved center pieces separate around a hinge to move apart and disengage the threaded rod. The daisy head may be rotated after the tube compressors are removed from the holders to move the tube compressors from the respective openings, allowing easier access to the holders. Alternatively, the motor can run in reverse, allowing the daisy head tube compressors to be removed from the holders so that exhausted tubes or cartridges can be removed and replaced with full tubes or cartridges.

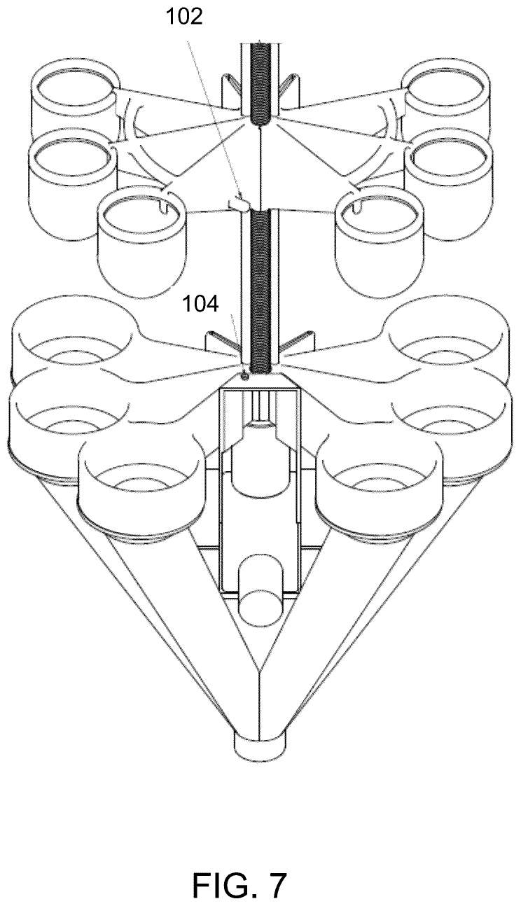

As seen in FIG. 5, the holders 40 comprise a circle or ellipse in cross-section, with an exterior and/or interior casing 92, 94 (which may be metal, plastic, or similar material), a layer of insulation 90, and/or a heating element 96. In the latter case, the holders may be heated if the ambient temperature gets too low, thereby allowing the liquid sealant to be at proper application temperature. The holders and/or the pack itself may be insulated, which will help retain heat and/or protect the liquid sealant from temperature extremes.

The pack further contains one or more batteries (which may be rechargable) or battery adapter 88a (to provide power from standard rechargable tool batteries 88b), electrically connected to provide power to the motor 80 and/or heaters 180. In one embodiment, certain batteries and/or adapters are designated for providing power to the motor, while others are designated for providing power to the heater.

Controls may be provided on the gun 54 and/or a control module 4a on the pack. The gun trigger or switch 56, when pulled, may activate the compression of the tubes or cartridges and cause the flow of the liquid sealant, and thus act as an on/off switch. A button 160 for reversing the direction of the motor may be provided. Similarly, a button and/or temperature control 162 may be provided for the heater.

The present invention allows a user to apply liquid sealant or caulk single-handedly (although two hands may be used, if desired) at the correct thickness (millage) and width, while avoiding frequent downtime to replace sealant cartridges or tubes.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A liquid sealant dispenser, comprising:
a backpack with an interior chamber housing a pressing device, the pressing device comprising
a plurality of holding tubes, each with a bottom end, an open top end, a hollow interior and a linear slot in a side thereof;
a daisy head with a center and a plurality of rods and compressor paddles attached thereto, each of said plurality of compressor paddles configured to fit and move within the hollow interior of a corresponding holding tube, with the corresponding rod configured to sliding move within the linear slot of the corresponding holding tube;
a holder frame with a center and a plurality of receivers, each receiver configured to hold the bottom end of a corresponding holding tube; and
a threaded rod extending from the center of the daisy head to a motor positioned below the holder frame, wherein the motor is attached to the threaded rod and configured to cause the threaded rod to rotate, thereby moving the daisy head up or down depending on the direction of rotation.

2. The dispenser of the claim 1, further comprising:
a converging funnel positioned under the holder frame;
a sealant application gun; and
a sealant hose running between the converging funnel and sealant application gun.

3. The dispenser of claim 2, wherein each holding tube is configured to hold a sealant tube or cartridge containing a liquid sealant, and when the motor causes the threaded rod to rotate in a direction moving the daisy head down, each of said plurality of compressor paddles simultaneously compresses the corresponding sealant tube or cartridge, forcing liquid sealant to flow from the sealant tube or cartridge into the converging funnel then into the sealant hose to the sealant application gun.

4. The dispenser of claim 3, wherein the sealant application gun comprises a trigger and a removable sealant tip for applying the liquid sealant.

5. The dispenser of claim 3, further comprising a rod or button on the center of the daisy head, and a corresponding rod or button or runout sensor on the holder frame.

6. The dispenser of claim 3, wherein each sealant tube or cartridge is removable and replaceable.

7. The dispenser of claim 1, wherein each holding tube is insulated.

8. The dispenser of claim 1, wherein each holding tube is heated.

9. The dispenser of claim 1, wherein each holding tube is insulated and heated.

10. The dispenser of claim 1, further comprise one or more compress guide rods extending upward parallel to the threaded rod, configured to fit within corresponding holes or slots in the center of the daisy head.

11. The dispenser of claim 1, wherein the daisy head has an open position and a closed position, wherein in the closed position the center of the daisy head is engagingly clamped around the threaded rod, and in the open position the center of the daisy head is disengaged from the threaded rod.

12. The dispenser of claim 1, further comprising one or more batteries.

13. The dispenser of claim 1, further comprising a direction of rotation control, and a temperature control.
